(19) United States
(12) Patent Application Publication
(10) Pub. No.: US 2012/0263945 A1
(43) Pub. Date: Oct. 18, 2012

(54) METHOD FOR MANUFACTURING FLEXIBLE GLASS SUBSTRATE AND FLEXIBLE GLASS SUBSTRATE

(75) Inventor: Minoru Yoshikawa, Tokyo (JP)

(73) Assignee: MICRO TECHNOLOGY CO., LTD., Tokyo (JP)

(21) Appl. No.: 12/992,176

(22) PCT Filed: Oct. 9, 2009
(86) PCT No.: PCT/JP2009/067625

§ 371 Date: Nov. 11, 2010

(51) Int. Cl. C03C 15/00; B32B 17/00

(52) U.S. Cl. 428/337; 216/36; 428/426

(57) ABSTRACT

[Problem to be Solved]

A method for producing a flexible glass substrate which is approximately 100% impermeable to gas or vapor and excellent in bendability and a flexible glass substrate are provided.

[Solution]

After forming of a pattern P on a surface of a glass substrate 1, a support 3 is temporarily attached to the surface, the glass substrate 1 is thinned by etching another surface of the glass substrate 1, a film base 5 is laminated to the etched another surface, and the temporarily attached support 3 is peeled off from the one surface of the glass substrate 1.

### TECHNICAL FIELD

The present invention relates to a method for manufacturing a flexible glass substrate which is approximately 100% impermeable to gas or vapor and excellent in bendability, and a flexible glass substrate.

### BACKGROUND ART

Recently, in the field of flat panel displays such as liquid crystal display devices and organic EL display devices, substituting a plastic film of a transparent polymer for a conventional glass substrate has been under study for improving a shatter resistance, reduction in weight, and reduction in thickness. Examples of such a film include a transparent conductive film for use in display composed of a polyethersulfone film having a small birefringence on which an indium oxide film is formed, which is described in Patent Literature 1.

A plastic film, however, has disadvantages such as a larger dimensional change caused by heat or moisture absorption and a lower impermeability to gas or vapor compared to glass.

As required by the circumstance, the present inventors invented a glass/film substrate composed of glass which is approximately 100% impermeable to gas or vapor laminated with a film (see Non Patent Literature 1). In the glass/film substrate, a glass and a film are laminated and the glass alone is thinned by etching to a thickness of 0.15 mm and thereby an unprecedented bendable glass substrate with a high barrier effect to gas or vapor and an excellent bendability was realized.

Since reducing a thickness of flat panel displays such as liquid crystal display devices and organic ELs or electronic papers is in a further progress, the present inventors also have further thinned the glass/film substrate described in the Non Patent Literature 1.

### PRIOR ART DOCUMENT

### Patent Literature

Patent Literature 1: Japanese Patent Laid-Open No. 59-158015

Non Patent Literature 1: “Bendable Glass: Component for EL/Electronic Paper” [online] January 2009, Micro Technology Co., Ltd. [searched on Oct. 7, 2009], Internet <URL: http://www.microtc.com/randd/index.html>

### SUMMARY OF INVENTION

### Problem to be Solved by the Invention

The present invention is aimed at improvement of the above-described glass/film substrate. An object of the invention is to provide a method for producing a flexible glass substrate which is drastically thinner than predecessors, approximately 100% impermeable to gas or vapor, excellent in flexibility for free and large bending, and to provide the flexible glass substrate.

### Means for Solving Problem

The present invention is a method for producing a flexible glass substrate in which a film base is laminated to a glass substrate for achieving the objects, comprising the steps of: temporarily attaching a support to a surface of a glass substrate; thinning the glass substrate by etching another surface of the glass substrate; laminating a film base to the etched another surface; and peeling off the temporarily attached support from the one surface of the glass substrate.

Also, the present invention is a method for producing a flexible glass substrate in which a film base is laminated to a glass substrate, comprising the steps of: temporarily attaching a support to one surface of the glass substrate after deposition treatment to the one surface; thinning the glass substrate by etching another surface of the glass substrate; laminating a film base to the etched another surface; and peeling off the temporarily attached support from the one surface of the glass substrate.

Also, the present invention is a method for producing a flexible glass substrate in which a film base is laminated to a glass substrate, comprising the steps of: temporarily attaching a support to one surface of the glass substrate after deposition treatment to the one surface; thinning the glass substrate by etching another surface of the glass substrate to a thickness of the glass substrate ranging from 2 μm to 30 μm; laminating a film base to the etched another surface; and peeling off the temporarily attached support from the one surface of the glass substrate.

Also, a flexible glass substrate according to the present invention is produced by: temporarily attaching a support to a surface of a glass substrate; thinning the glass substrate by etching another surface of the glass substrate; laminating a film base to the etched another surface; and peeling off the temporarily attached support from the one surface of the glass substrate.

Also, a flexible glass substrate according to the present invention is produced by: temporarily attaching a support to one surface of the glass substrate after deposition treatment to the one surface; thinning the glass substrate by etching another surface of the glass substrate; laminating a film base to the etched another surface; and peeling off the temporarily attached support from the one surface of the glass substrate.

Also, a flexible glass substrate according to the present invention is produced by: temporarily attaching a support to one surface of the glass substrate after deposition treatment to the one surface; thinning the glass substrate by etching another surface of the glass substrate to a thickness of the glass substrate ranging from 2 μm to 30 μm; laminating a film base to the etched another surface; and peeling off the temporarily attached support from the one surface of the glass substrate.

### Advantageous Effects of Invention

In the present invention, a support is temporarily attached to a surface of a glass substrate, the glass substrate is thinned by etching another surface of the glass substrate, a film base is laminated to the etched another surface, and the temporarily attached support is peeled off from the one surface of the glass substrate. Consequently, provided is a flexible glass substrate which is approximately 100% impermeable to gas or vapor, drastically thinner than predecessors, and enhanced in bending property.

### BRIEF DESCRIPTION OF DRAWING

FIG. 1 illustrates a method for producing a flexible glass substrate according to the present invention.

### MODE FOR CARRYING OUT THE CLAIMED INVENTION

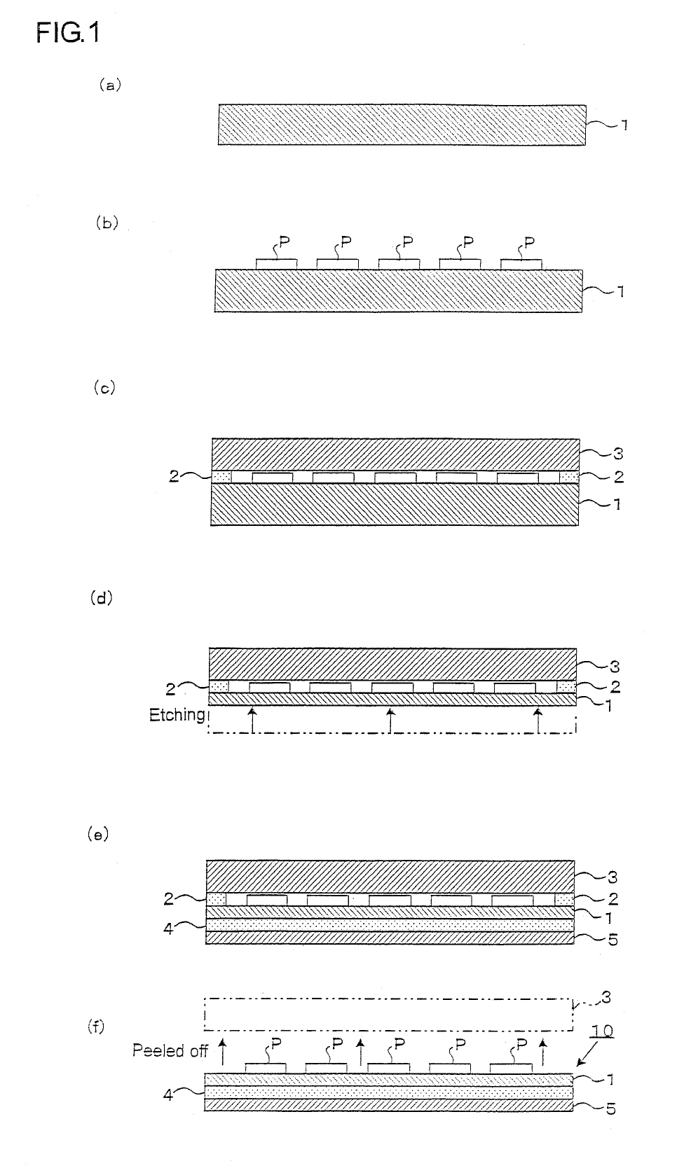

The best mode for carrying out the invention will be explained in detail with reference to the attached drawings. FIG. 1 illustrates a method for producing a flexible glass substrate according to the present invention. In FIG. 1, although the etched glass substrate shown in (f) has a smaller thickness compared to the glass substrate shown in (a), the same reference numeral is used to designate the same part having a different thickness.

As shown in FIG. 1(f), a flexible glass substrate 10 of the present invention is an ultrathin glass substrate 1 in which a pattern P is formed on a glass substrate 1 and a film base 5 is laminated to the glass substrate 1 by an adhesive 4.

A flexible glass substrate 10 of the present invention is used for making thin displays such as liquid crystal displays, organic EL displays, plasma panel displays, and electronic papers.

The pattern P can be formed on the glass substrate 1 by various existing methods. Examples of the methods include deposition of indium tin compound oxide (ITO) through a dry process such as vacuum vapor deposition or sputtering.

Material used for the film base 5 in the present invention is not specifically limited. For example, polycarbonate, polyethylene terephthalate, polyethylene naphthalate, polyether sulfone, polyimide, an epoxy resin, a phenol resin, a melamine resin, polyurethane, polyurea, polyethylene, polypropylene, a nylon resin, polyvinyl chloride, an acrylic resin, polystyrene, an acrylonitrile butadiene styrene resin, an acrylonitrile styrene resin, or polyvinylidene chloride may be used.

The thickness of the film base 5 used in the present invention is not specifically limited. A thickness of not larger than 500 μm is preferred for enhancing flexibility. A thickness of not smaller than 1 μm is preferred for securing strength. A thickness of not smaller than 25 μm is preferred for ease of handling.

A method for producing a flexible glass substrate 10 will be explained below in detail with reference to FIG. 1.

First, as shown in FIG. 1(a), a glass substrate 1 is prepared. Although the thickness of the glass substrate 1 is not specifically limited, a preferred thickness ranges from 0.2 mm to 0.7 mm considering workability. A size of the unprocessed glass substrate 1 is appropriately determined considering ease of handling relative to a sheet thickness. For example, a 300 mm square or a 400 mm square for a sheet thickness of 0.2 mm and a 1 m square for a sheet thickness of 0.7 mm may be used.

Subsequently, after deposition treatment is carried out to a surface of the glass substrate 1 (i.e. the upper surface in FIG. 1(b)) by CVD, sputtering, deposition, or plating, a pattern P is formed by photo-etching or printing. In the present invention, since the pattern can be formed on a glass substrate 1 having a large sheet thickness, a large size of the substrate can be used. In addition, in a process at a high temperature ranging from 150° C. to 350° C. required for the pattern configuration, a plastic film has a problem with heat resistance. On the contrary, the present invention has no problem with heat resistance, since the pattern is formed on the glass substrate 1 prior to the lamination of the film base 5.

Subsequently, as shown in FIG. 1(c), a support 3 is temporarily attached through an adhesive 2 to the one surface of the glass substrate 1 having the pattern P formed thereon. Although a glass sheet or a resin sheet is available for the support 3, an elastic film material may also be used. The adhesive 2 is applied to a peripheral portion of the glass substrate 1 in order to readily peel off the support 3 later. An acid-resisting adhesive is used for the adhesive 2 to prevent invasion by an etching solution into a space between the glass substrate 1 and the support 3 during the etching.

Subsequently, as shown in FIG. 1(d), another surface of the glass substrate 1 (i.e. the lower surface in FIG. 1(d)) is thinned through etching using hydrofluoric acid. In the present invention, the glass substrate 1 is thinned to a sheet thickness ranging from 2 μm to 30 μm. In the present invention, since the glass substrate 1 can be etched in a state having the support 3, a drastically thinner substrate can be achieved compared to a glass/film substrate described in the Non Patent Literature 1.

After the glass substrate 1 is thinned to a desired thickness by the etching, as shown in FIG. 1(e), a film base 5 is laminated to another surface of the glass substrate 1 (i.e. the lower surface in FIG. 1(e)) by an adhesive 4. A heat-resisting acrylic adhesive is used for the adhesive 4.

Subsequently, as shown in FIG. 1(f), the support 3 temporarily attached to a surface of the glass substrate 1 is peeled off from the glass substrate 1. Consequently, a flexible glass substrate 10 of the present invention is made. A method such as softening treatment by heat, photolytic degradation, or peeling by a blade may be used for peeling off.

As described above, the flexible glass substrate of the present invention is produced by: temporarily attaching a support to one surface of the glass substrate after deposition treatment to the one surface; thinning the glass substrate by etching another surface of the glass substrate; laminating a film base to the etched another surface; and peeling off the temporarily attached support from the one surface of the glass substrate. Thereby an approximately 100% impermeability to gas or vapor is achieved with an unprecedented drastically thinner thickness, and an enhanced bending property. That is, a passivation effect can be achieved without impairing flexing properties of a film.

The flexible glass substrate of the present invention may be used not only for a field such as flat panel displays or electronic papers but also for a wider field such as electronics, electric apparatus, cells, or optical elements as an alternative to a film. Although the glass substrate in the embodiment described above has a formed pattern, a glass substrate with deposition treatment alone or having an unprocessed surface may be also used as a flexible glass substrate of the present invention.

### Reference Signs List

1 Glass substrate
2 Adhesive
3 Support
4 Adhesive
5 Film base
10 Flexible glass substrate
P Pattern

1-6. (canceled)

7. A method for producing a flexible glass substrate in which a film base is laminated to a glass substrate, comprising the steps of:
temporarily attaching a support to a first surface of the glass substrate after deposition treatment to the first surface;
thinning the glass substrate by etching a second surface of the glass substrate;
laminating the film base to the etched second surface; and
peeling off the temporarily attached support from the first surface of the glass substrate.

8. The method claim 7, wherein the step of thinning the glass substrate by etching a second surface of the glass substrate is performed to a thickness of the glass substrate ranging from 2 μm to 30 μm.

9. A flexible glass substrate produced by:
temporarily attaching a support to a first surface of the glass substrate after deposition treatment to the first surface;
thinning the glass substrate by etching a second surface of the glass substrate;
laminating a film base to the etched second surface; and
peeling off the temporarily attached support from the first surface of the glass substrate.

10. The flexible glass substrate of claim 9, wherein the step of thinning the glass substrate by etching the second surface of the glass substrate is performed to a thickness of the glass substrate ranging from 2 μm to 30 μm.

11. A method for producing a flexible glass substrate in which a film base is laminated to a glass substrate, comprising the steps of:
forming a pattern on a first surface of the glass substrate after deposition treatment to the first surface and temporarily attaching a support to the first surface of the glass substrate;
thinning the glass substrate by etching a second surface of the glass substrate;
laminating the film base to the etched second surface; and
peeling off the temporarily attached support from the first surface of the glass substrate.

12. A flexible glass substrate produced by:
forming a pattern on a first surface of the glass substrate after deposition treatment to the first surface and temporarily attaching a support to the first surface of the glass substrate;
thinning the glass substrate by etching a second surface of the glass substrate;
laminating a film base to the etched second surface; and
peeling off the temporarily attached support from the first surface of the glass substrate.
